(19) United States
(12) Patent Application Publication
(10) Pub. No.: US 2011/0013901 A1
(43) Pub. Date: Jan. 20, 2011

(54) IMAGING MODULE AND METHOD OF ADJUSTING IMAGING

(76) Inventor: Makoto UTSUGI, Saitama-shi (JP)

Correspondence Address: BIRCH STEWART KOLASCH & BIRCH, PO BOX 747, FALLS CHURCH, VA, 22040-0747, US

(21) Appl. No.: 12/822,590

(22) Filed: Jun. 24, 2010

(30) Foreign Application Priority Data
Jul. 14, 2009 (JP) P2009-165941

(51) Int. Cl. G03B 17/00

(52) U.S. Cl. 396/529

(57) ABSTRACT

The invention provides an imaging module in which a lens barrel is reliably adhered and fixed to a device holder regardless of the amount of adjustment and a method of adjusting the imaging of the imaging module.

An imaging module includes: a lens barrel that is a cylindrical body with an opened front surface and an opened rear surface and has an imaging lens held therein; and a device holder including a cylindrical portion which faces an outer circumferential surface of the lens barrel with a gap therebetween and surrounds the outer circumferential surface of at least a portion of the lens barrel close to the rear surface. An imaging device is fixed to the device holder at a position facing the rear surface of the lens barrel, and the lens barrel is adhered to the device holder.

### CROSS-REFERENCE TO RELATED APPLICATIONS

This application is based upon and claims the benefit of priority from the Japanese Patent Application No. 2009-165941 filed on Jul. 14, 2009; the entire contents of which are incorporated herein by reference.

### BACKGROUND OF THE INVENTION

1. Field of the Invention

The present invention relates to an imaging module that focuses object light on an imaging device using an imaging lens and a method of adjusting the imaging of the imaging module.

2. Description of the Related Art

In recent years, most of mobile phones are provided with imaging modules. It is necessary to minimize the size of the imaging module in order to provide the imaging module in the mobile phone. For example, an imaging module has been proposed which includes two main components, that is, a lens barrel having an imaging lens held therein and a device holder having the imaging device fixed thereto in order to reduce the size thereof. In the imaging module, screws are provided between the lens barrel and the device holder, and during focus adjustment, the lens barrel is screwed to be moved forward or backward relative to the device holder in the optical axis direction, thereby disposing the imaging device at the imaging position of the imaging lens held in the lens barrel. Then, the lens barrel is adhered and fixed to the device holder by an adhesive. In this way, the size of the imaging module is reduced.

However, when screws are provided in both the lens barrel for adjusting focus and the device holder, the diameters of both the lens barrel and the device holder increase.

In recent years, the size and thickness of the mobile phone have been reduced. Therefore, the size and thickness of the imaging module need to be further reduced in the near future in order to provide the imaging module in the mobile phone.

A technique has been proposed in which the screws provided between the lens barrel and the device holder are removed, the lens barrel is moved relative to the device holder to perform optical axis adjustment, back focal length adjustment, or tilt adjustment, and the rear surface of the lens barrel which is provided on an imaging side and the front surface of the device holder which is provided on an object side adhere to each other in a non-contact state (so-called adhesion with a gap) to fix the lens barrel to the device holder (for example, JPA-2007-274230).

In the imaging module disclosed in JP-A-2007-274230, the rear surface of the lens barrel is adhered to the front surface of the device holder with a gap therebetween. Therefore, the gap between the rear surface of the lens barrel and the front surface of the device holder for adhesion with a gap therebetween increases according to the amount of optical axis adjustment, back focal length adjustment, or tilt adjustment. In this case, there is a concern that the lens barrel will not be reliably adhered and fixed to the device holder.

### SUMMARY OF THE INVENTION

The invention has been made in order to solve the above-mentioned problems and an object of the invention is to provide an imaging module in which a lens barrel is reliably adhered and fixed to a device holder regardless of the amount of adjustment and a method of adjusting the imaging of the imaging module.

According to an aspect of the invention, there is provided an imaging module that focuses object light on an imaging device through an imaging lens. The imaging module includes: a lens barrel that is a cylindrical body with an opened object-side surface and an opened imaging-side surface and has an imaging lens held therein; and a device holder that includes a cylindrical portion which surrounds an outer circumferential surface of the lens barrel with a gap therebetween. An imaging device is fixed to the device holder at a position facing the imaging-side surface of the lens barrel, and the lens barrel is fixed to the device holder.

In the invention, the ‘imaging device’ means an image sensor, such as a CCD (Charge Coupled Device) image sensor or a CMOS (Complementary Metal Oxide Semiconductor) image sensor.

In the imaging module according to the above-mentioned aspect of the invention, the outer circumferential surface of the lens barrel is surrounded by the cylindrical portion of the device holder, and a gap is formed between the cylindrical portion and the outer circumferential surface of the lens barrel. It is possible to fill the gap with an adhesive for adhering the device holder to the lens barrel. Therefore, according to the imaging module of the above-mentioned aspect of the invention, it is possible to reliably adhere and fix the lens barrel to the device holder using the gap, regardless of the amount of optical axis adjustment, back focal length adjustment, or tilt adjustment.

In the imaging module according to the above-mentioned aspect of the invention, the lens barrel may be adhered to the device holder using the gap in a state in which the formation of an image on the imaging device by the imaging lens held by the lens barrel is adjusted relative to the device holder.

According to this structure, it is possible to reliably adhere and fix the lens barrel to the device holder using the gap, regardless of the adjusted position.

In the imaging module according to the above-mentioned aspect of the invention, the cylindrical portion of the device holder may protrude forward from the object-side surface of the lens barrel.

According to this structure, for example, even when an impact is applied to the leading end of the cylindrical portion or the object-side surface of the lens barrel due to, for example, falling, the cylindrical portion protruding forward from the object-side surface of the lens barrel prevents the impact from being directly applied to the lens barrel. As a result, it is possible to prevent the lens barrel from peeling off from the device holder due to the impact.

In the imaging module according to the above-mentioned aspect of the invention, the lens barrel may have concave portions provided in the object-side surface of the lens barrel.

According to this structure, for example, during optical axis adjustment, back focus adjustment, or tilt adjustment, it is possible to reliably position the lens barrel with respect to the device holder by fitting a positioning jig to the concave portions.

In the imaging module according to the above-mentioned aspect of the invention, the device holder may have cutouts which are provided in the cylindrical portion of the device holder and through which portions of the outer circumferential surface of the lens barrel coming into contact with the object-side surface of the lens barrel are exposed.

According to this structure, for example, during optical axis adjustment, back focus adjustment, or tilt adjustment, it is possible to reliably hold the lens barrel by holding the portions exposed through the cutouts with, for example, a jig.

In the imaging module in which the cylindrical portion of the device holder protrudes forward from the object-side surface of the lens barrel according to the above-mentioned aspect of the invention, a metal film may be formed on the outer surface of the device holder.

According to this structure, since the metal film is formed on the outer surface of the device holder, the imaging module is electromagnetically shielded by the metal film at a sufficient level for practical use.

According to another aspect of the invention, there is provided a method of adjusting the imaging of an imaging module that focuses object light on an imaging device through an imaging lens and includes a lens barrel which is a cylindrical body with an opened object-side surface and an opened imaging-side surface and has an imaging lens held therein, and a device holder which includes a cylindrical portion surrounding an outer circumferential surface of the lens barrel with a gap therebetween, an imaging device being fixed to the device holder at a position which faces the imaging-side surface of the lens barrel. The method includes: adjusting the position of the lens barrel relative to the device holder using the gap to adjust the formation of an image on the imaging device by the imaging lens held by the lens barrel; and adhering and fixing the lens barrel to the device holder with the formation of the image adjusted.

The imaging adjustment method according to the above-mentioned aspect of the invention adjusts the imaging of the imaging module according to the above-mentioned aspect. Therefore, the lens barrel is reliably adhered and fixed to the device holder, regardless of the amount of adjustment.

The above-mentioned aspects of the invention provide an imaging module in which a lens barrel is reliably adhered and fixed to a device holder, regardless of the amount of adjustment and a method of adjusting the imaging of the imaging module.

### BRIEF DESCRIPTION OF THE DRAWINGS

FIG. 1 is a perspective view illustrating an imaging module according to an embodiment of the invention, as obliquely viewed from the upper front side;

FIG. 2 is a cross-sectional view taken along the line A-A of FIG. 1;

FIG. 3 is a longitudinal cross-sectional view illustrating an imaging module according to another embodiment of the invention; and

FIG. 4 is a longitudinal cross-sectional view illustrating an imaging module according to still another embodiment of the invention.

### DESCRIPTION OF THE PREFERRED EMBODIMENTS

Hereinafter, exemplary embodiments of the invention will be described with reference to the accompanying drawings.

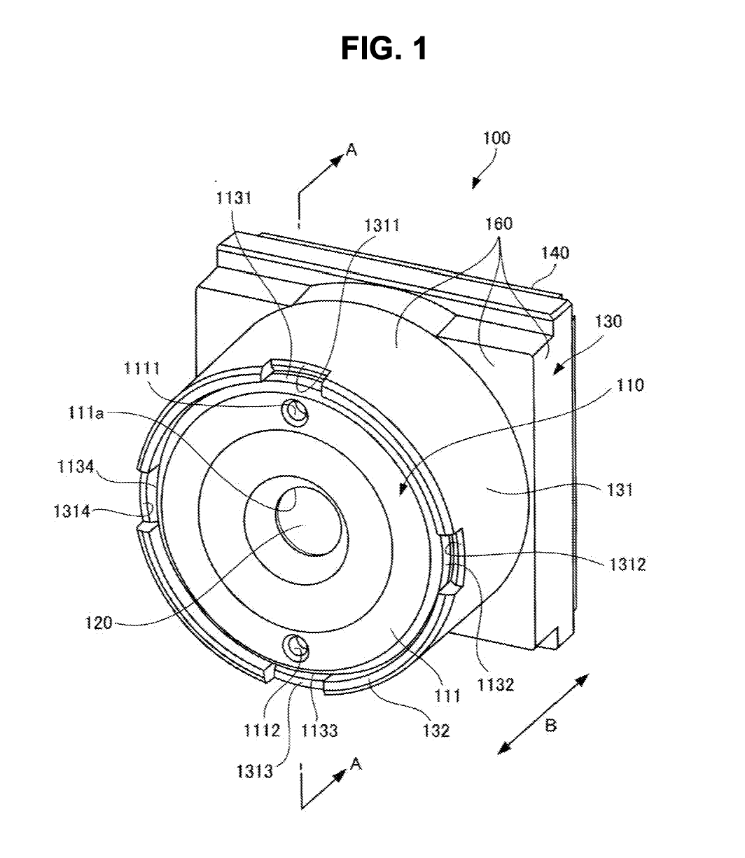

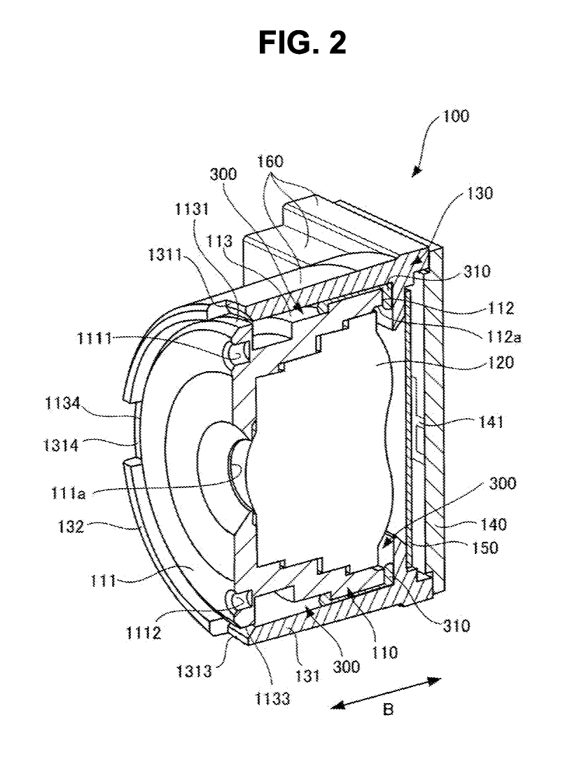

FIG. 1 is a perspective view illustrating an imaging module 100 according to an embodiment of the invention, as obliquely viewed from the upper front side. FIG. 2 is a cross-sectional view taken along the line A-A of FIG. 1.

The imaging module 100 shown in FIGS. 1 and 2 includes a lens barrel 110 and a device holder 130.

The lens barrel 110 holds an imaging lens 120. In this embodiment, the imaging lens 120 includes four lenses. However, in the drawings, the imaging lens 120 is simply shown as one block. The lens barrel 110 includes a front surface 111 which is provided on an object side, a rear surface 112 which is provided on an imaging side, and an outer circumferential surface 113 which is interposed between the front surface 111 and the rear surface 112. The front surface 111 has an object-side opening 111a, and the rear surface 112 has an imaging-side opening 112a. That is, the lens barrel 110 is a cylindrical body. The lens barrel 110 further includes two concave portions 1111 and 1112 provided in the front surface 111. A positioning jig (not shown) is fitted to the concave portions 1111 and 1112. For example, during optical axis adjustment, back focus length adjustment, or tilt adjustment, the positioning jig (not shown) is fitted to the concave portions 1111 and 1112 to reliably position the lens barrel 110 with respect to the device holder 130.

A gap 300 is formed between the device holder 130 and an outer circumferential surface 113 of the lens barrel 110 and the device holder 130 has a cylindrical portion 131 that surrounds the outer circumference of at least the rear surface 112 of the lens barrel 110. As shown in FIGS. 1 and 2, the cylindrical portion 131 protrudes forward from the front surface 111 of the lens barrel 110. Specifically, the length of the device holder 130 in the direction of an arrow B, which is the optical axis direction, is more than that of the lens barrel 110 in the direction of the arrow B, and the front surface 132 of the device holder 130 protrudes from the front surface 111 of the lens barrel 110.

The device holder 130 is adhered to the lens barrel 110 using the gap 300 in the state in which the formation of an image on an imaging device 141 by the imaging lens 120 that is held by the lens barrel 110 is adjusted with respect to the device holder 130. Specifically, for example, a thermosetting adhesive 310 is applied on a portion of the lens barrel 110 in which the gap 300 is formed, and the lens barrel 110 having the adhesive 310 applied thereon is inserted into the device holder 130. Before the lens barrel 110 is adhered and fixed to the device holder 130, the lens barrel 110 is moved relative to the device holder 130 to perform optical axis adjustment, back focus length adjustment, or tilt adjustment. After the adjustment operation, heat is applied to the adhesive 310 in the gap 300 from the outside of the device holder 130 to harden the adhesive 310. In this way, the device holder 130 is adhered to the lens barrel 110 with a gap therebetween. It is possible to reliably adhere and fix the lens barrel 110 to the device holder 130 using the gap 300, regardless of the amount of adjustment.

A circuit board 140 having the imaging device 141 mounted thereon is fixed to the device holder 130 at a position facing the rear surface 112 of the lens barrel 110. In addition, an infrared cut filter 150 that prevents infrared rays from being incident on the imaging device 141 is fixed between the circuit board 140 and the rear surface 112 of the lens barrel 110 in the device holder 130.

A metal film 160 is formed on the outer surface of the device holder 130, that is, the outer surface of a portion of the device holder 130 which is close to the rear surface 112 and to which the circuit board 140 is fixed and the outer surface of the cylindrical portion 131. The metal film 160 is formed by, for example, a vapor deposition process. In this embodiment, as an example of the metal film 160, a stainless film is formed after a copper film is formed.

The device holder 130 includes four cutouts 1311, 1312, 1313, and 1314 which are provided in the cylindrical portion 131 at regular intervals on the circumference thereof and through which portions 1131, 1132, 1133, and 1134 of the outer circumferential surface 113 that comes into contact with the front surface 111 of the lens barrel 110 are exposed. The cutouts 1311, 1312, 1313, and 1314 are provided in order to hold the lens barrel 110. For example, during optical axis adjustment, back focus length adjustment, or tilt adjustment, a jig (not shown) holds the portions 1131, 1132, 1133, and 1134 exposed through the cutouts 1311, 1312, 1313, and 1314 to reliably hold the lens barrel 110.

Next, an imaging adjustment method according to an embodiment of the invention will be described.

The following imaging adjustment method is a method of adjusting the imaging of the imaging module 100 described with reference to FIGS. 1 and 2. Specifically, the imaging adjustment method adjusts the imaging of the imaging module 100 including the lens barrel 110 which is a cylindrical body with the opened front surface 111 and the opened rear surface 112 and has the imaging lens 120 held in the cylindrical body, and the device holder 130 that includes the cylindrical portion 131 which faces the outer circumferential surface 113 of the lens barrel 110 with the gap 300 interposed therebetween and surrounds the outer circumference of at least a portion of the lens barrel 110 close to the rear surface 112. In this structure, the imaging device 141 is fixed to the device holder 130 at a position that faces the rear surface 112 of the lens barrel 110.

First, the position of the lens barrel 110 relative to the device holder 130 is adjusted using the gap 300, thereby adjusting the formation of an image on the imaging device 141 by the imaging lens 120 held by the lens barrel 110.

Then, the lens barrel 110 is adhered and fixed to the device holder 130 while maintaining the position where the formation of the image is adjusted.

The imaging adjustment method has been described above.

In the imaging module 100 according to this embodiment, the lens barrel 110 is adhered to the device holder 130. However, the outer circumferential surface 113 of the lens barrel 110 is surrounded by the cylindrical portion 131 of the device holder 130, and the cylindrical portion 131 protrudes forward from the front surface 111 of the lens barrel 110. Therefore, the imaging module 100 has high impact resistance. For example, when the imaging module 100 falls with the leading end, which is an object side, facing downward, the lens barrel 110 is less likely to be impacted.

In the assembly of the imaging module 100 according to this embodiment, during the adhesion between the lens barrel 110 and the device holder 130, when the lens barrel 110 is moved relative to the device holder 130 in order to perform optical axis adjustment, back focus length adjustment, or tilt adjustment, the lens barrel 110 is disposed within the region surrounded by the cylindrical portion 131 of the device holder 130. Therefore, the dimension, that is, the overall length of the imaging module 100 according to this embodiment in the direction of the arrow B, which is the optical axis direction, is settled to the dimension of the device holder 130 to which the circuit board 140 having the imaging device 141 mounted thereon is fixed in the direction of the arrow B. That is, the dimension of the imaging module 100 according to this embodiment in the direction of the arrow B is fixed without varying depending on optical axis adjustment, back focus length adjustment, or tilt adjustment. Therefore, for example, when the imaging module 100 is incorporated into a portable electronic apparatus, it is easy to design an accurate structure.

In general, when a metal film is formed on the surface of the imaging module, the metal film serves as an electromagnetic shield and prevents the influence of noise due to, for example, electromagnetic waves. The metal film may be formed by, for example, a vapor deposition process.

In the imaging module 100 according to this embodiment, the outer circumferential surface 113 of the lens barrel 110 is surrounded by the cylindrical portion 131 of the device holder 130, and the metal film 160 is formed on the outer surface of a portion of the device holder 130 to which the circuit board 140 is fixed and which is close to the rear surface 112 and the outer surface of the cylindrical portion 131. The imaging module 100 is electromagnetically shielded by the metal film 160 at a sufficient level for practical use. Therefore, according to the imaging module 100 of this embodiment, it is not necessary to provide a metal film for an electromagnetic shield on the lens barrel 110.

The imaging module 100 according to the embodiment of the invention has been described above.

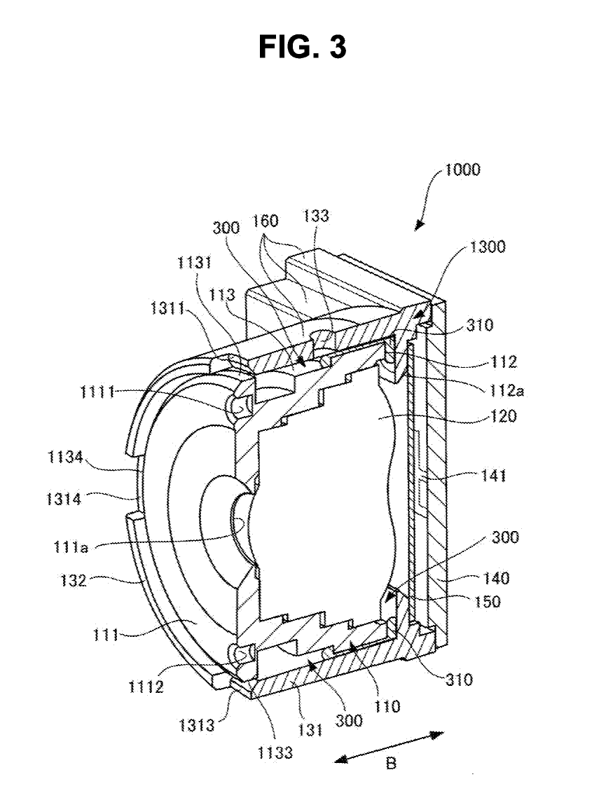

Next, an imaging module 1000 according to another embodiment of the invention will be described with reference to FIG. 3.

In the following embodiment, the same components as those in the above-described embodiment are denoted by the same reference numerals and a description thereof will be omitted. Only the difference between this embodiment and the above-described embodiment will be described below.

FIG. 3 is a longitudinal cross-sectional view illustrating the imaging module 1000 according to another embodiment of the invention.

The imaging module 1000 shown in FIG. 3 includes a lens barrel 110 and a device holder 1300.

The device holder 1300 includes a plurality of through holes 133 that is formed in the cylindrical portion 131 in a direction intersecting the optical axis. In FIG. 3, one through hole 133 is shown. However, for example, five through holes 133 are provided in the circumferential direction.

The device holder 1300 is adhered to the lens barrel 110 using the gap 300 in the state in which the formation of an image on an imaging device 141 by the imaging lens 120 that is held by the lens barrel 110 is adjusted relative to the device holder 1300. Specifically, before the lens barrel 110 is adhered and fixed to the device holder 1300, the lens barrel 110 is moved relative to the device holder 1300 to perform optical axis adjustment, back focus length adjustment, or tilt adjustment. After the adjustment operation, for example, a thermosetting adhesive 310 flows into the gap 300 through the through holes 133 while maintaining the positional relationship between the lens barrel 110 and the device holder 1300, and heat is applied to the adhesive 310 in the gap 300 from the outside of the device holder 1300 to harden the adhesive 310. In this way, the device holder 1300 is adhered to the lens barrel 110 with a gap therebetween. Therefore, it is possible to reliably adhere and fix the lens barrel 110 to the device holder 1300 using the gap 300, regardless of the amount of adjustment.

The imaging module 1000 according to another embodiment of the invention has been described above.

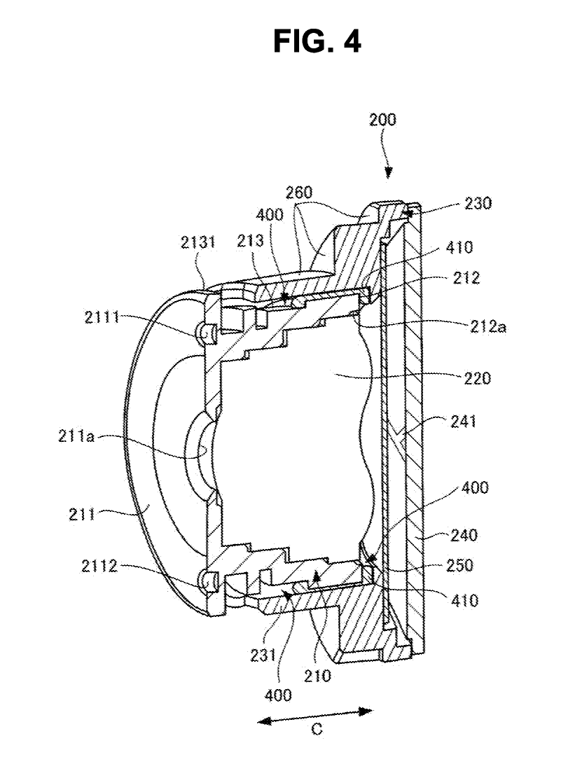

Next, an imaging module 200 according to still another embodiment of the invention will be described with reference to FIG. 4.

FIG. 4 is a longitudinal cross-sectional view illustrating the imaging module 200 according to still another embodiment of the invention.

The imaging module 200 shown in FIG. 4 includes a lens barrel 210 and a device holder 230.

An imaging lens 220 is held by the lens barrel 210. The imaging lens 220 includes four lenses. However, in FIG. 4, the imaging lens 220 is simply shown as one block. The lens barrel 210 includes a front surface 211 which is provided on an object side, a rear surface 212 which is provided on an imaging side, and an outer circumferential surface 213 which has a large-diameter portion 2131 coming into contact with the front surface 211 and is interposed between the front surface 211 and the rear surface 212. The front surface 211 has an object-side opening 211a, and the rear surface 212 has an imaging-side opening 212a. That is, the lens barrel 210 is a cylindrical body. The large-diameter portion 2131 is provided in order to hold the lens barrel 210. For example, during optical axis arrangement, back focal length arrangement, or tilt adjustment, a jig (not shown) holds the large-diameter portion 2131, thereby reliably holding the lens barrel 210. The lens barrel 210 includes two concave portions 2111 and 2112 provided in the front surface 211. A positioning jig (not shown) is fitted to the concave portions 2111 and 2112. For example, during optical axis adjustment, back focus length adjustment, or tilt adjustment, the positioning jig (not shown) is fitted to the concave portions 2111 and 2112 to reliably position the lens barrel 210 with respect to the device holder 230.

A gap 400 is formed between the device holder 230 and an outer circumferential surface 213 of the lens barrel 210 and the device holder 230 has a cylindrical portion 231 that surrounds the outer circumference of at least the rear surface 212 of the lens barrel 210. As shown in FIG. 4, the cylindrical portion 231 surrounds the outer circumferential surface except for the front surface 211 and the large-diameter portion 2131 of the lens barrel 210. Specifically, the length of the device holder 230 in the direction of an arrow C, which is the optical axis direction, is less than that of the lens barrel 210 in the direction of the arrow C, and the front surface 211 and the large-diameter portion 2131 of the lens barrel 210 are exposed. Therefore, it is possible to hold the large-diameter portion 2131. For example, it is easy to perform optical axis adjustment, back focus length adjustment, or tilt adjustment.

The device holder 230 is adhered to the lens barrel 210 using the gap 400 in the state in which the formation of an image on an imaging device 241 by the imaging lens 220 that is held by the lens barrel 210 is adjusted relative to the device holder 230. Specifically, for example, a thermosetting adhesive 410 is applied on a portion of the lens barrel 210 in which the gap 400 is formed, and the lens barrel 210 having the adhesive 410 applied thereon is inserted into the device holder 230. Before the lens barrel 210 is adhered and fixed to the device holder 230, the lens barrel 210 is moved relative to the device holder 230 to perform optical axis adjustment, back focus length adjustment, or tilt adjustment. After the adjustment operation, heat is applied to the adhesive 410 in the gap 400 from the outside of the device holder 230 to harden the adhesive 410. In this way, the device holder 230 is adhered to the lens barrel 210 with a gap therebetween. Therefore, it is possible to reliably adhere and fix the lens barrel 210 to the device holder 230 using the gap 400, regardless of the amount of adjustment.

A circuit board 240 having the imaging device 241 mounted thereon is fixed to the device holder 230 at a position facing the rear surface 212 of the lens barrel 210. In addition, an infrared cut filter 250 that prevents infrared rays from being incident on the imaging device 241 is fixed between the circuit board 240 and the rear surface 212 of the lens barrel 210 in the device holder 230.

A metal film 260 is formed on the outer surface of the device holder 230, that is, the outer surface of a portion of the device holder 230 which is close to the rear surface 212 and to which the circuit board 240 is fixed and the outer surface of the cylindrical portion 231. The metal film 260 is formed by, for example, a vapor deposition process. In this embodiment, as an example of the metal film 260, after a copper film is formed, a stainless film is formed.

In the imaging module 200 having the above-mentioned structure shown in FIG. 4, the outer circumference of the lens barrel 210 except for the front surface 211 and the large-diameter portion 2131 is surrounded by the cylindrical portion 231 of the device holder 230, and the metal film 260 is formed on the outer surface of a portion of the device holder 230 to which the circuit board 240 is fixed and which is close to the rear surface 212 and the outer surface of the cylindrical portion 231. Therefore, the large-diameter portion 2131 is exposed, but the imaging module 200 is electromagnetically shielded by the metal film 260 at a sufficient level.

In the above-described embodiments of the invention, the imaging lens includes four imaging lenses, but the invention is not limited thereto. The number of imaging lenses is not particularly limited.

In the above-described embodiments of the invention, the lens barrel fixedly holds the imaging lens, but the invention is not limited thereto. The lens barrel may hold an actuator that moves the imaging lens in the optical axis direction to adjust focus.

In the above-described embodiments of the invention, the cylindrical portion of the device holder is a circular cylinder, but the cylindrical portion of the device holder is not limited to the circular cylinder. For example, the cylindrical portion of the device holder may be a rectangular cylinder having an inner circumferential surface and/or an outer circumference surface with a rectangular cylindrical shape as long as it faces the outer circumferential surface of the lens barrel with a gap interposed therebetween and surrounds the outer circumferential surface of the lens barrel.

What is claimed is:

1. An imaging module that focuses object light on an imaging device through an imaging lens, comprising:
a lens barrel that is a cylindrical body with an opened object-side surface and an opened imaging-side surface and has an imaging lens held therein; and
a device holder that includes a cylindrical portion which surrounds an outer circumferential surface of the lens barrel with a gap therebetween,
wherein an imaging device is fixed to the device holder at a position facing the imaging-side surface of the lens barrel, and
the lens barrel is fixed to the device holder.

2. The imaging module according to claim 1,
wherein the lens barrel is adhered to the device holder using the gap in a state in which the formation of an image on the imaging device by the imaging lens held by the lens barrel is adjusted relative to the device holder.

3. The imaging module according to claim 1,
wherein the cylindrical portion of the device holder protrudes forward from the object-side surface of the lens barrel.

4. The imaging module according to claim 1,
wherein the lens barrel has concave portions that are provided in the object-side surface of the lens barrel.

5. The imaging module according to claim 1,
wherein the device holder has cutouts which are provided in the cylindrical portion of the device holder and through which portions of the outer circumferential surface of the lens barrel coming into contact with the object-side surface of the lens barrel are exposed.

6. The imaging module according to claim 3,
wherein a metal film is formed on the outer surface of the device holder.

7. A method of adjusting the imaging of an imaging module that focuses object light on an imaging device through an imaging lens and includes a lens barrel which is a cylindrical body with an opened object-side surface and an opened imaging-side surface and has an imaging lens held therein, and a device holder which includes a cylindrical portion surrounding an outer circumferential surface of the lens barrel with a gap therebetween, an imaging device being fixed to the device holder at a position which faces the imaging-side surface of the lens barrel, the method comprising:
adjusting the position of the lens barrel relative to the device holder using the gap to adjust the formation of an image on the imaging device by the imaging lens held by the lens barrel; and
adhering and fixing the lens barrel to the device holder in the state in which the formation of the image is adjusted.
